(19) United States
(12) Patent Application Publication
(10) Pub. No.: US 2002/0171471 A1
(43) Pub. Date: Nov. 21, 2002

(54) Regulating circuit for a high voltage generator

(75) Inventors: Jean-Felix Perotto, Colombier (CH); Olivier Rey, Lignieres (CH)

Correspondence Address: SUGHRUE MION, PLLC, 2100 PENNSYLVANIA AVENUE, N.W., WASHINGTON, DC, 20037, US

(73) Assignee: EM MICROELECTRONIC-MARIN SA

(21) Appl. No.: 10/144,041

(22) Filed: May 14, 2002

(30) Foreign Application Priority Data
May 18, 2001 (EP) 01201889.1

(51) Int. Cl. G05F 1/10

(52) U.S. Cl. 327/540

(57) ABSTRACT

A regulating circuit for a high voltage generator, used in particular for supplying a non-volatile memory, includes an amplitude modulator (101) which receives at input terminals at least two clock signals (phi; nphi) and which supplies at output terminals at least two modulated clock signals (102; 103) to a charge pump (104). The circuit also includes a feedback loop, connecting an output of the charge pump to said amplitude modulator. This loop includes a comparator (109), which receives at a first input terminal an output quantity (Ibr) from the charge pump and at a second input terminal a reference quantity (Ipol), and which supplies at an output a comparison signal (Ucomp).

The feedback loop further includes an analogue low-pass filter (105) at the output of said comparator converting said comparison signal into an analogue control signal (106) for the amplitude modulator.

The present invention concerns a regulating circuit for a high voltage generator, used in particular for supplying a non-volatile memory. The regulating circuit comprises an amplitude modulator which receives at input terminals at least two clock signals and which supplies at output terminals at least two modulated clock signals to a charge pump. It also comprises a feedback loop, which connects an output of the charge pump to said amplitude modulator. This feedback pump comprises a comparator which receives at a first input terminal an output quantity from the charge pump and at a second input terminal a reference quantity, and which supplies at its output a control signal for the amplitude modulator.

These circuits are generally used for supplying non-volatile programmable memories of the EEPROM type. Regulating the output voltage of a charge pump enables the charge pump's energy consumption to be reduced and avoids subjecting the programmable memory cells to too much stress particular during writing and deleting phases.

Such a regulating circuit via modulation of clock signals received at input terminals is already known in the prior art, in particular from WO Patent Application No. 98/27477. This document presents a circuit enabling the output of a charge pump to be regulated by varying the amplitude and frequency of the clock signals received at input terminals. The disclosed circuit shows a combination of a frequency modulation and an amplitude modulation. A feedback loop is used to control the amplitude and frequency modulators according to the output current or voltage requirements of the charge pump. Indeed, depending on the load placed at the pump output, the power consumed varies substantially. It is thus advantageous to be able to act on the charge pump so that it supplies the adequate power at its output.

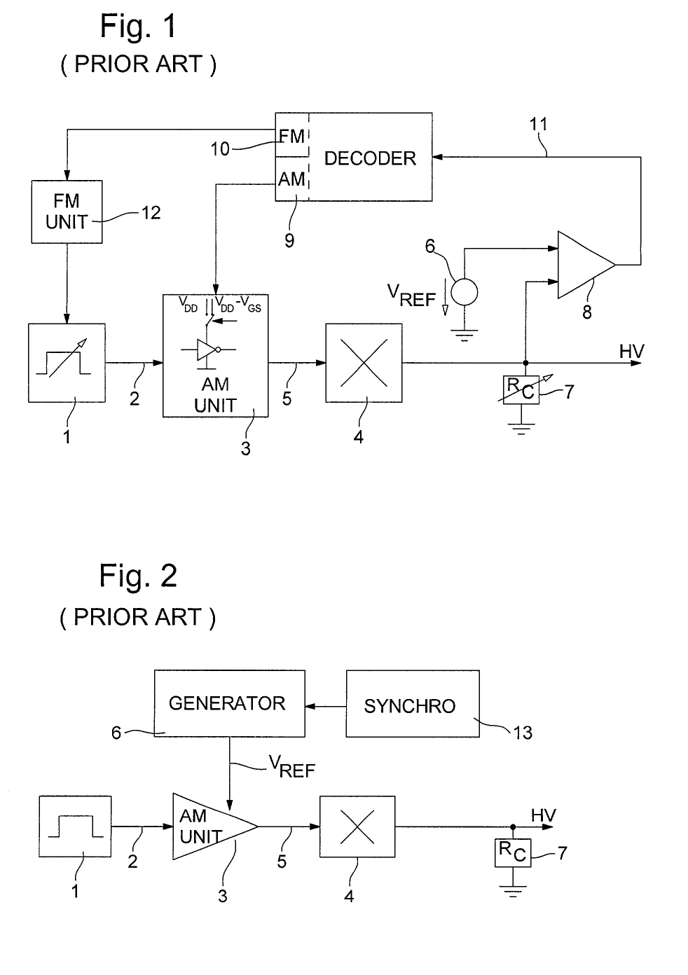

In this document, as shown in FIG. 1, a variable frequency oscillator I delivers one or more multiphase clock signals 2. These clock signals are then amplitude modulated through an amplitude modulation unit 3. This unit 3 supplies charge pump 4 with amplitude modulated clock signals 5 enabling the pump stages to be controlled. Charge pump 4 delivers at its output a high voltage HV intended to power a non-volatile memory, which is not shown. The load corresponding to the memory is shown in the form of a variable resistor Rc7, placed at the output of the regulating circuit.

High voltage HV supplied at the output of charge pump 4 is derived in a feedback loop which includes, in series, a comparator 8 and a pair of AM and FM decoders, respectively 9 and 10. Comparator 8 thus receives the high output voltage HV delivered by charge pump 4, and a reference voltage Vref, delivered by a direct-current voltage generator 6, proportional to the voltage necessary for supplying the memory. The result of the comparison 11 is transmitted to decoders 9 and 10, responsible for sending control signals for the modulation units. AM decoder 9 controls amplitude modulation unit 3, and FM decoder 10 controls frequency modulation unit 12.

Frequency modulation unit 12 is connected to variable frequency oscillator 1 and depending on the command received from FM decoder 10, i.e. depending on the requirements of load 7 and/or the variations in the circuit supply voltage, allows the frequency of clock signals 2 to be modulated.

Amplitude modulation unit 3 includes a combination of MOS transistors powered by a direct-current voltage VDD and connected to inverters receiving clock signals 2. Depending on the command received from AM decoder 9, it is possible to obtain a discrete voltage command from the inverters at two or three levels, for example VDD and VDD-VGS, VGS being the threshold voltage of one of the transistors. These different voltage levels allow the amplitude of clock signals 2, received by the inverters placed at the input of charge pump 4, to be modulated.

However, a regulating circuit of this type has several drawbacks. In particular, the amplitude modulation is limited to the two or three accessible voltage levels. Moreover, these voltage levels are high, either the maximum charge voltage (Vdd), or a charge voltage close to this maximum voltage (Vdd-Vgs) and depending on the circuit supply voltage (Vdd). Thus, in the case of a low load 7, the power required at the output of charge pump 4 is also low, and the regulation obtained by modulating the amplitude of the clock signals is insufficient. In this case, the power consumption remains too high. Likewise, in the event of an increase in the circuit supply voltage (Vdd), the energy saving is inefficient, since it depends on said supply voltage (Vdd).

This is why this document proposes the combination of an amplitude modulation unit 3 and a frequency modulation unit 12. But the effect of this combination is to substantially complicate the regulating circuit, both as regards the decoding and as regards the oscillator, which has to have a variable frequency. These elements are complex and take a significant amount of space in the integrated circuit.

There is also known from the prior art, in particular from U.S. Pat. No. 5,945,870, a regulating circuit, which regulates solely by means of a clock signal amplitude modulation. As is shown in FIG. 2, the regulating circuit, according to this document, comprises an oscillator 1, supplying a clock signal 2. This signal 2 is then amplitude modulated in a unit 3, which supplies an amplitude modulated clock signal 5 to a charge pump 4, which delivers a high voltage HV at the output of the circuit. Amplitude modulation unit 3 is controlled by a variable voltage generator 6, which is itself controlled by a timing control circuit 13.

Generator 6 is capable of delivering, at its output, a large number of voltage levels Vref between a voltage VDD and 0. These voltage levels control inverters present in amplitude modulation unit 3, said inverters being placed at the input of charge pump 4, in order to modulate the amplitude of clock signals 2 received by said inverters.

However, this circuit also has several drawbacks. In particular, the absence of a feedback loop requires the use of a timing control circuit 13 which knows, in advance, the output response as a function of time, and thus knows the load Rc 7 placed at the output of pump 4. The load 7 used must thus be fixed and known, which considerably restricts the possibilities for using the circuit. In the case of a new load, timing control circuit 13 has to be reprogrammed.

Moreover, a variable voltage generator 6, as it is described, comprises an equivalent number of stages to the number of voltage levels, which can be generated, which quickly makes it complex and voluminous in the integrated circuit.

In order to avoid the aforementioned drawbacks of the prior art, the present invention concerns a regulating circuit as defined in the preamble, characterised in that the feedback loop further comprises an analogue low-pass filter at the output of the comparator transforming the comparison signal into an analogue control signal for the amplitude modulator.

Such a regulating circuit is advantageous in that it is simple and economical in the space that it occupies in the integrated circuit. Indeed, the solution proposed includes neither a combination of frequency and amplitude modulation, requiring the use of a variable frequency oscillator, nor a variable voltage generator, controlled by a time control circuit.

Moreover, the command sent to the amplitude modulator is an analogue signal which can vary over a wide range enabling a large control range to be obtained with very fine resolution, and thus enables the power consumed at the output of the charge pump to be regulated, even for significant variations in the load and/or the circuit supply voltage.

Another advantage of the invention is that it regulates the high output voltage in order to extend as far as possible the lifetime of the programmable memory cells. This is why the regulation voltage chosen is a voltage close to the so-called “breakdown” voltage of the transistors present in the non-volatile memory. Thus, this high output voltage is just sufficient to programme the memory cells and is not too high so as to avoid programming them in high stress conditions.

In an advantageous embodiment of the invention, the comparison made at the output of the charge pump is a comparison between a breakdown current of a drain-substrate junction of a transistor placed at the output, breaking down in a similar manner to those used in the programmable memory cells, and a reference current.

The invention will be explained in detail hereinafter via an embodiment, which is given solely by way of example, this embodiment being illustrated by the annexed drawings, in which:

FIG. 1 shows a regulating circuit according to the prior art,

FIG. 2 shows a regulating circuit according to another prior art,

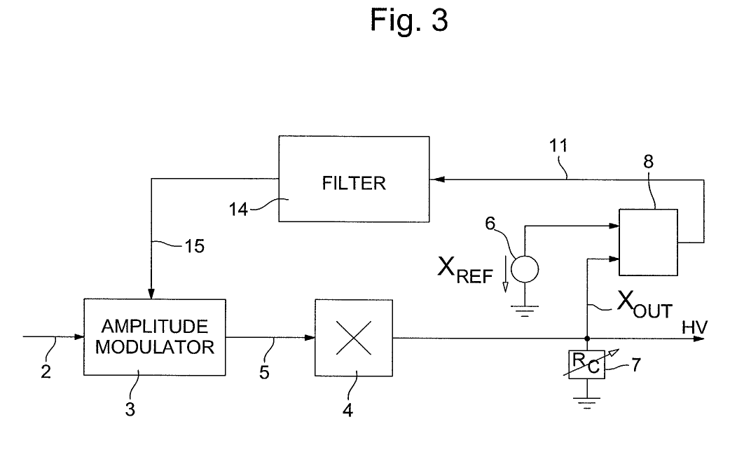

FIG. 3 shows schematically the regulating circuit according to the invention, and

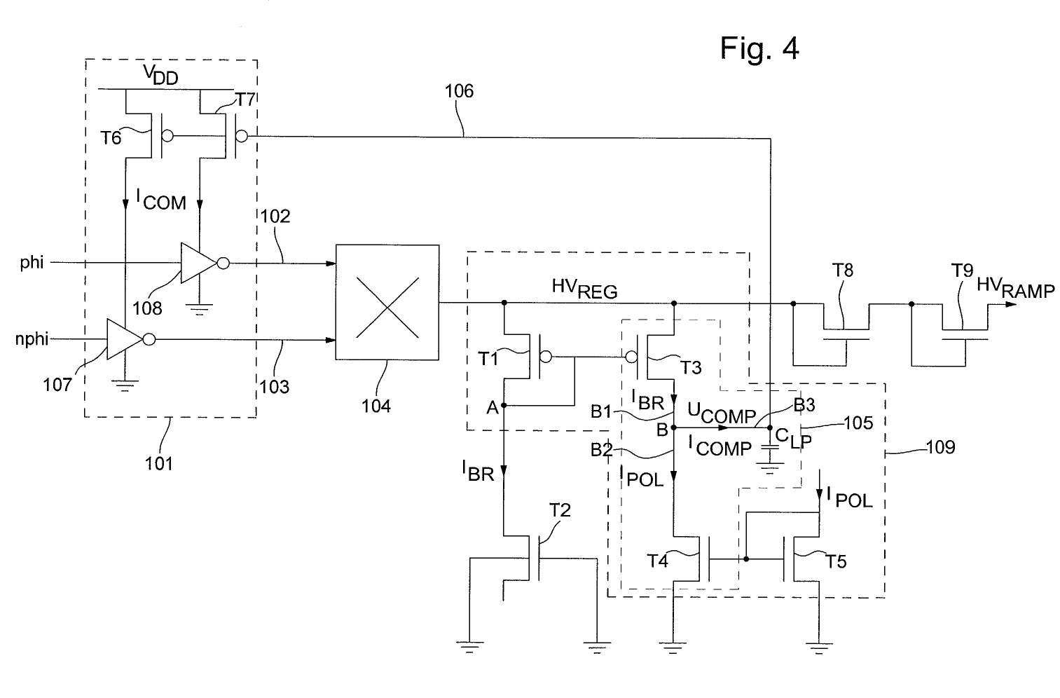

FIG. 4 shows in detail the regulating circuit according to the invention,

FIGS. 1 and 2 have already been described within the scope of the description of the prior art.

FIG. 3 is a schematic diagram, according to a similar model to the description of the prior art, of the regulating circuit according to the invention. An oscillator, which is not shown, supplies at the output of the circuit a biphase clock signal 2. An amplitude modulator 3 receives this clock signal 2 at input terminals and converts it into a modulated biphase clock signal 5. This modulated signal 5 enables the different stages of a charge pump 4 to be controlled, said pump delivering at the output of the circuit a high voltage HV, used to supply a non-volatile memory, represented by an equivalent variable load Rc 7.

The regulation circuit includes a feedback loop containing a comparator 8 and a low-pass filter 14. An output quantity Xout is recuperated to be supplied to one input of comparator 8, which also receives at a second input a reference quantity Xref supplied by a generator 6. The result of comparison 11 is filtered through low-pass filter 14, in order to be converted into an analogue control signal 15 for amplitude modulator 3. Filter 14 also assures the stability of the regulation loop.

Output quantity Xout may be, in particular, a current or a voltage, reference quantity Xref being a quantity homogeneous with output quantity Xout. Provided that this output quantity Xout is less than reference quantity Xref, the result of comparison 11 remains zero. Command 15 is thus zero, i.e. no amplitude modulation is carried out. Clock signal 4, at output terminals of amplitude modulator 3, corresponds to inverted clock signal 2.

When output quantity Xout becomes greater than reference quantity Xref, the result of comparison 11 becomes positive and the analogue control signal 15 increases so that the amplitude of clock signal 5 decreases. Clock signal 2 is thus amplitude modulated at output terminals of modulator 3, following the evolution of command 15.

As output voltage HV from charge pump 4 is dependent on the amplitude of the phases of received modulated clock signal 5 and on the number of stages making up pump 4, this voltage HV can be decreased or increased depending on the amplitude of the phases of modulated clock signal 5.

FIG. 4 is a detailed diagram of the regulating circuit according to the invention. Preferably, two clock signals will be used, or similarly, a biphase clock signal, but it is however possible to use four clock signals or a quadriphase clock signal or any other combination of clock signals allowing the rise in voltage of the charge pump to be optimised.

In the example illustrated, there are two clock signals with the two signals phi and nphi being substantially offset by 180°. An amplitude modulator 101 receives the two signals phi and nphi at input and supplies at its output two modulated clock signals 102 and 103 to a charge pump 104.

In a conventional manner, a Dickson type charge pump will be used, providing a high positive output voltage Hvreg. It is however possible to use another type of charge pump, in particular a negative charge pump.

The transistors used, in this embodiment example, are MOS technology transistors. The PMOS transistors are distinguished from the NMOS transistors by the addition of a circle to their gate.

In order to reduce the power consumed at the output, the object of this circuit is to regulate this output voltage Hvreg to the value of a voltage called the “breakdown” voltage Ubr of the transistors used in the memory. A “breakdown” voltage means the voltage of the drain-substrate junction of an MOS transistor, when the intensity of the electric field in the junction reaches the value necessary for the first ionising shock to be generated among the charge carriers forming the low reverse current.

In order to determine whether the output voltage Hvreg has reached the breakdown voltage Ubr, a floating source transistor T2, breaking down in a similar manner to those used in the memory cells, is placed at the output of charge pump 104. Thus, the voltage applied at the output of the memory will always be as high as possible, without thereby subjecting the transistors present in the memory to high stress conditions, taking account of the voltage drop in transistors T8 and T9 placed for this purpose.

As soon as output voltage Hvreg exceeds this breakdown voltage Ubr, transistor T2 breaks down and a breakdown current Ibr appears in the branch between node A and the drain of transistor T2.

Moreover, a reference “polarisation” current Ipol allows the breakdown detection level of transistor T2 to be fixed. A comparator 109, formed by transistors T1, T3, T4 and T5 allow these two currents Ibr and Ipol to be compared. The result of the comparison is used to control the feedback loop. The object thereby sought is to regulate this breakdown current Ibr to the value of polarisation current Ipol.

The breakdown current Ibr is reflected by means of transistors T1 and T3, forming a first current mirror. The same current Ibr is thus found in branch B1 between the source of transistor T3 and node B. Polarisation current Ipol is reflected by means of transistors T4 and T5, forming a second current mirror. Thus, current Ipol is found again in branch B2 between the drain of transistor T4 and node B. The current starting from node B in the feedback loop is a comparison current Icomp between the breakdown current Ibr and polarisation current Ipol. In accordance with the law of nodes, applied to node B, this current has a value of Ibr-Ipol. The variable currently used to feedback to the amplitude modulator is the voltage Ucomp corresponding to this comparison current Icomp. This voltage Ucomp is given by the following relation:

Ucomp=G*(Ibr-Ipol)

Where G represents the transresistance of current comparator 109 formed by transistors T1, T3, T4 and T5.

The example given uses a current comparator but it is also possible to use an equivalent device allowing the breakdown voltage to be compared to a reference voltage.

A low-pass filter 105, for example formed by a capacitor Clp and by the conductance of transistors T3 and T4, is introduced into the loop. Thus, the command sent to the gates of transistors T6 and T7 is an analogue command 106. Indeed, the filter allows the high harmonics of comparison voltage Ucomp to be removed, and only its direct-current component (DC) to pass. It is to be noted that the example given is preferably formed by a low-pass filter of the first order, but could also be formed by a low-pass filter of the second order.

Once the regulating circuit has stabilised, this analogue control voltage 106 varies between 0 volts and a voltage close to the circuit supply voltage Vdd, generally several volts.

Indeed, as long as breakdown current Ibr is zero, node B behaves like a capacitive node. No current flows in branch B1 between the source of transistor T3 and node B, and polarisation current Ipol comes out of node B towards the drain of transistor T4. The potential of node B decreases in a capacitive manner. Ucomp can thus be assimilated to a zero voltage, for a zero breakdown current Ibr.

Once breakdown voltage Ubr is reached at the output of charge pump 104, breakdown current Ibr appears and is reflected into branch Bi, this current Ibr entering node B. When the incoming current Ibr becomes greater than the outgoing current Ipol, voltage Ucomp at node B increases and feeds back onto amplitude modulator 101 in order to reduce the action of charge pump 104, which allows entry into the actual regulation phase.

During this regulation phase, breakdown current Ibr varies in a controlled manner in comparison with fixed polarisation current Ipol, which causes controlled variations in comparison voltage Ucomp. It is to be noted that the variations in comparison voltage Ucomp, during this regulation phase, are around a slightly greater voltage than threshold Vtn of transistor T4, referenced to the reference potential Vss. Comparison voltage Ucomp is thus lower than, while remaining independent of the circuit supply voltage Vdd. These features of voltage Ucomp allow, in particular, the power consumed as a function of variations in load Rc 7, but also as a function of variations in circuit supply voltage Vdd, to be regulated.

Amplitude modulator 101 includes adjusting means, such as for example two transistors T6 and T7, receiving analogue control voltage 106, in series with two inverters 107 and 108. Transistors T6 and T7 are connected such that their drain is connected to supply voltage Vdd, their source is connected to the two inverters, respectively 107 and 108, and their gate is connected to control voltage 106. During the regulation phase, the control voltage is always lower than supply voltage Vdd, transistors T6 and T7 are thus always in an ON-state.

In a conventional manner, the inverters used are CMOS transistors formed of a first PMOS transistor in series with a second NMOS transistor. Inverter 107 is thus formed by transistors P107 and N107, which are not shown, and inverter 108 is formed by transistors P108 and N108, which are also not shown.

The source of transistor T6 is connected to a direct-current supply VDD, its drain is connected to the source of transistor P107 and its gate receives analogue control voltage 106. The drain of transistor P107 is connected to the source of transistor N107 and its gate is connected to that of transistor N107, the drain of transistor N107 being connected to a reference potential. The gates of transistors P107 and N107 receive clock signal nphi, and the drain of transistor P107 as well as the source of transistor N107 deliver modulated clock signal 103.

The same is true of the arrangement of transistors T7, P108 and N108, the received clock signal being phi and the modulated clock signal being the signal 102. Thus, each clock signal (phi, nphi) is modulated through inverters 107 and 108 to give the modulated signals 102 and 103 at output. It is to be noted that one will preferably use as many inverters as clock signals at input terminals.

The current Icom passing from the drain of each of transistors T6 and T7 to their respective source depends on the value of this control voltage 106. If control voltage 106 is zero, the current Icom supplied to inverters 107 and 108, by transistors T6 and T7, is maximum. Conversely, if voltage 106 increases, the current Icom supplied to inverters 107 and 108, by transistors T6 and T7, decreases. It is important to note that since control voltage 106 is analogue, the current Icom supplied to inverters 107 and 108 is also analogue.

Inverter 107 receives clock signal nphi at a first input terminal and inverter 108 receives clock signal phi at a second input terminal. The two inverters are fed by substantially the same current Icom provided by the feedback loop. Thus, they are current controlled in an analogue manner.

According to another embodiment of the invention, which is not shown, a single transistor allowing the two inverters 107 and 108 to be controlled by means of a single current Icom replaces the two transistors T6 and T7.

The global operation of the regulating circuit results in the increase in a voltage HVreg at the output of pump 104 up to the predefined breakdown voltage Ubr. Once this level is reached, a breakdown current Ibr appears, this current is compared to a predefined polarisation current Ipol. The result of the comparison is used in the form of a comparison voltage Ucomp. This voltage Ucomp is filtered by means of a low-pass filter 105 to obtain an analogue control voltage 106. This control voltage 106 feeds back onto amplitude modulator 101 placed at the input of charge pump 104. Ir This amplitude modulator 101 converts the received control voltage 106 into an analogue control current Icom, allowing the amplitude of clock signals phi and nphi used to control charge pump 104 to be controlled. This modulation amplitude has the effect of reducing voltage Hvreg at the output of the pump. Conversely, when output voltage HVreg is less than breakdown voltage Ubr, control voltage 106 feeds back so as to make charge pump 104 operate at maximum capacity again. The result is the regulation of output voltage Hvreg around breakdown voltage Ubr.

It is to be noted that in reality, the effective regulation voltage HVreg at the output of the charge pump is a voltage HVreg equal to breakdown voltage Ubr to which the threshold voltage of transistor T1 is added. Since this regulation voltage is greater than breakdown voltage Ubr, preferably at least one transistor is placed at the output of the circuit in order to lower said voltage. In the example shown, two transistors T8 and T9 are placed at the output of the regulating circuit in order to lower this voltage HVreg by two threshold voltages. Thus, voltage Hvramp received by the memory is less than breakdown voltage Ubr by approximately one threshold voltage.

According to a variant of the invention, it is also possible to connect the source of transistor T2 to a reference potential Vss, like the circuit earth. In this case, the transistor's breakdown voltage is determined either by the breakdown of the drain-substrate junction, or by the breakdown of the short channel of said transistor.

It is to be noted that the description mentions the generation of a positive high voltage, but it is also possible to make an equivalent regulating circuit by generating a negative high voltage.

It is also to be noted that the description mentions the use of transistors of MOS technology, but it is also possible to make the same regulating circuit by using transistors of bipolar technology.

It is clear that the description is given only by way of example and that other embodiments may form the subject of the present invention.

What is claimed is:

1. Regulating circuit for a high voltage generator, used in particular for supplying a non-volatile memory, including an amplitude modulator which receives at input terminals at least two clock signals and which supplies at output terminals at least two modulated clock signals to a charge pump, a feedback loop, connecting an output of the charge pump to said amplitude modulator, said feedback loop including a comparator which receives at a first input terminal an output quantity from said charge pump and at a second input terminal a reference quantity, and which supplies at an output a comparison signal wherein said feedback loop further includes an analogue low-pass filter at the output of said comparator converting said comparison signal into an analogue control signal for said amplitude modulator.

2. Regulating circuit for a high voltage generator according to claim 1, wherein said amplitude modulator includes adjusting means receiving said analogue control signal, said adjusting means being in series with at least one inverter, and said adjusting means allowing said inverter to be current controlled.

3. Regulating circuit for a high voltage generator according to claim 2, wherein said adjusting means are formed of at least one transistor.

4. Regulating circuit for a high voltage generator according to claim 1, wherein said comparator is a current comparator, wherein said output quantity of the charge pump is a breakdown current of a drain-substrate junction of a transistor with a floating source, said transistor with a floating source being placed at the output of the charge pump and wherein said reference quantity is a polarisation current fixing a breakdown detection level.

5. Regulating circuit for a high voltage generator according to claim 3, wherein said comparator is a current comparator, wherein said output quantity of the charge pump is a breakdown current of a drain-substrate junction of a transistor with a floating source, said transistor with a floating source being placed at the output of the charge pump and wherein said reference quantity is a polarisation current fixing a breakdown detection level.

6. Regulating circuit for a high voltage generator according to claim 5, wherein said comparator includes a first current mirror reflecting said breakdown current into a first branch towards a node B and a second current mirror reflecting said polarisation current into a second branch towards said node B, and wherein said node B includes a third branch through which a comparison current, connected to the comparison signal, passes.

7. Regulating circuit for a high voltage generator according to claim 6, wherein said first current mirror is formed of a first transistor and a second transistor, said first transistor being connected between the output of the charge pump and said floating source transistor, said second transistor being connected to the output of the charge pump and said first branch connected to node B, and wherein said second current mirror is formed of a third transistor and a fourth transistor, said third transistor being connected between a polarisation current source and a reference potential, said fourth transistor being connected between said reference potential and said second branch connected to node B.

8. Regulating circuit for a high voltage generator according to claim 7, wherein said analogue low-pass filter is formed by a capacitance connected between a reference potential and said third branch connected to node B, and by a conductance of said second and fourth transistors of the current mirrors.

9. Regulating circuit for a high voltage generator according to claim 8, wherein at least one other transistor is placed at the output of the charge pump to be connected to a non-volatile memory.

10. Regulating circuit for a high voltage generator according to claim 1, wherein said at least two clock signals are substantially offset by 180°.

11. Regulating circuit for a high voltage generator according to claim 1, wherein said amplitude modulator receives four clock signals at input terminals, said modulator including adjusting means and four inverters each receiving one of said clock signals.
